(19) United States
(12) Patent Application Publication
(10) Pub. No.: US 2013/0007501 A1
(43) Pub. Date: Jan. 3, 2013

(54) SYSTEM AND METHOD FOR IDENTIFYING REPAIR POINTS AND PROVIDING EFFECTIVE DISPATCH

(76) Inventors: Marcelo E. Areal, Indianapolis, IN (US); Jonathan B. Cahill, Fishers, IN (US)

(21) Appl. No.: 13/416,804

(22) Filed: Mar. 9, 2012

Related U.S. Application Data
(60) Provisional application No. 61/450,970, filed on Mar. 9, 2011.

(51) Int. Cl. G06F 11/07

(52) U.S. Cl. 714/2; 714/E11.023

(57) ABSTRACT

Systems and methods are disclosed for identifying repair points reported by individuals at one or more locations in a geographic area, and providing an effective process for dispatching repair crews. Event data related to a repair point is provided, where the event data is processed to determine the type(s) of repair needed, times and locations of reported events, as well as relationships between events and priority. This information is then used to prioritize dispatch to repair crews to address the events, and further monitor repair crews to determine status of repairs, and to further update priorities relating to ongoing repairs.

### RELATED APPLICATIONS

The present application claims priority to U.S. Provisional Application No. 61/450,970 to Marcelo Areal and Jonathan (“Jay”) Cahill, titled “System and Method for Identifying Repair Points and Providing Effective Dispatch,” filed Mar. 9, 2011, which is incorporated by reference in its entirety herein.

### TECHNICAL FIELD

The present disclosure relates to computer-based systems and methods for identifying geographic points in an area requiring repair, and for effectively providing communications for dispatch to effect repairs.

### BACKGROUND INFORMATION

Many state and local municipalities have significant concerns regarding the identification of infrastructure defects and/or damage, and have further struggled in finding effective ways through which infrastructure repairs can be carried out. In the case of road repair, local governments and other entities have been interested in quickly identifying defects, such as potholes, in order to correct problems before they become significant. It is estimated that, for every dollar spent on fixing small problems before they get bigger, between $6 and $7 are saved that would be spent on larger reconstructions.

Private entities also have a significant interest in ensuring that regional infrastructures are maintained. Each year, hundreds of billions of dollars worth of commodities are transported through state and local highways and local roads. It is well-known that potholes and other road damage contribute significantly to congestion. As commercial trucking represents an ever-increasing means for moving goods, minimizing the deleterious effects of potholes becomes more important. As an example, if costs for a driver are $60 an hour, and increased commuter times due to road repair or detour routing adds 200 hours per year, a business with a fleet of 100 delivery vehicles would incur an additional $1.2 million each year. If rough pavement adds $300 per vehicle costs every 12 months, this can result in an additional $300,000 in repair costs.

Thus, effective “pavement preservation” becomes crucial for mitigating significant deterioration in the infrastructure. Continuing with the road repair example, numerous surface treatments are available to extend a road's service life. These include:

Fog seals

Slurry seals

Chip seals

Cape seals

Sand seals

Rejuvenators

Micro-surfacing

Thin lift overlays

High-quality pothole repair

Crack sealing

Portland cement concrete joint sealing

Dowel-bar retrofit

Full and partial-depth concrete pavement repair

Milling and grinding

All of these are most effective when applied on a timely basis, before small cracks grow larger. For example, if any of the four indicators of road deterioration in a flexible pavement surface are present—presence of potholes, cracks, ruts or deformation—it is a trigger to use one or several methods for correcting the problem.

As mentioned above, the most familiar pavement deterioration is potholes. Found in arctic and tropical climates alike, a pothole is a late-stage problem that begins with a simple crack that allows water accumulation under the surface of the road. If a fog or slurry seal is not applied in time, the pothole can still be fixed with hot or cold asphalt filler. Hot asphalt treatments are historically more common, but incur expensive labor costs. Cold asphalt treatments apply advanced technologies that are both easier to use and more effective, lasting several years after application.

While the application of these treatments is well-known, identifying and following-up on areas in which treatment is needed has been more problematic. Pothole detection systems have been proposed using cell-phone “apps” in conjunction with accelerometers and GPS to detect and report potholes, but these systems provide limited information, and/or have a tendency to produce “false positives” with respect to potholes, which can result in wasteful and/or redundant dispatching of work crews to areas. Furthermore, these systems do not provide effective on-going monitoring of specific issues and prioritizing dispatch in order to resolve issues based on the severity of the issue being flagged.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram illustrating a reporting and dispatching system under an exemplary embodiment;

FIG. 2A is a flowchart illustrating an exemplary process for reporting events under one embodiment;

FIG. 2B is a flowchart illustrating and exemplary process for receiving and processing reports issued in the process of FIG. 2A;

FIG. 3 is a flowchart illustrating an exemplary process for computing optimized dispatch instructions using the processed reports of FIG. 2B;

FIG. 4 illustrates a map view of reported events relative to detected locations of crews and current progress under an exemplary embodiment.

### DETAILED DESCRIPTION

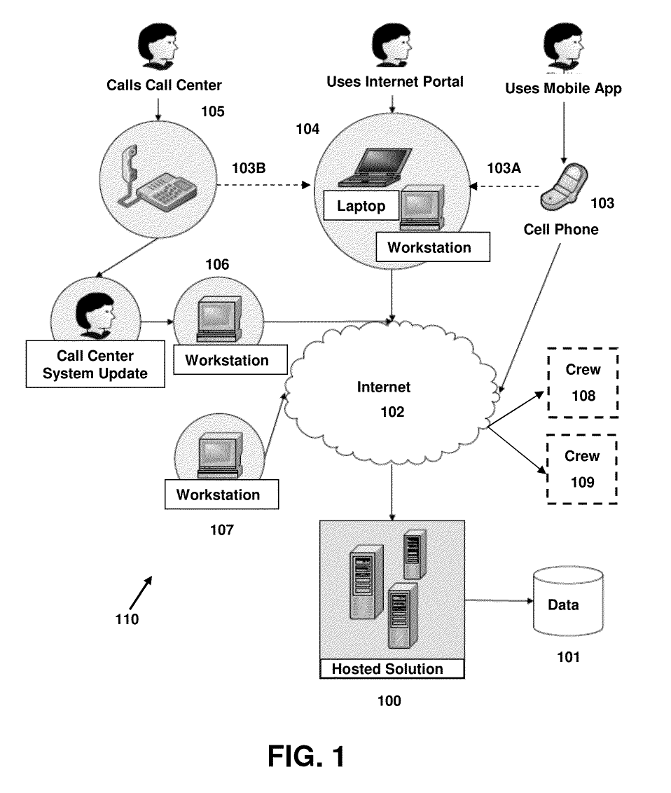

FIG. 1 illustrates an exemplary system 110 for reporting and processing incoming maintenance “events” from the general public, along with a dispatching system for communicating with maintenance crews. For the purposes of this application, “events” are defined as an environmental state or condition of an object, area, thing or structure that may require assistance, maintenance and/or repair. Such events include, but are not limited to, trash pickup, flooding, abandoned vehicles, potholes, and the like.

System 110 includes three primary means of communicating events: telephones 105, computing devices 104 and cell phones 103. In the case of reports issued by telephone 105, a citizen reports events to a call center employee, who then enters the event data into workstation 106, where the event data is further transmitted via Internet 102 to host 100, where the event data is processed and stored 101. In the case of reports issued by computing device 104, a citizen enters event data into a web page or web portal (not shown) that is preferably provided by host 100. The event data is then communicated over the Internet 102 to host 100, where the event data is processed and stored 101. In the case of reports issued by cell phones 103, event data is entered actively or passively (discussed in greater detail below), where it is communicated over the Internet 102 to host 100, where the event data is processed and stored 101. Under an alternate embodiment, phones 105, 103 may be equipped with suitable software that allows event data to be transmitted, wirelessly or via line connection, to computing device 104. Examples of such connections include WiFi, Bluetooth™, USB and the like.

Stored event data is made accessible to one or more workstations 107, where the event data is combined with scheduling data and location data to generate dispatch messages to remote crew teams (108, 109) equipped with suitable smart phones or similar devices. Under an alternate embodiment, host 100 may be configured to automatically generate dispatch messages to crews, with minimal to no user interaction.

Under a preferred embodiment, host 100 is comprised of one or more servers equipped with software (e.g., SQL, GPS) embodied in a tangible medium, which allows host 100 to process incoming reports in order to tag specific events and create/manage sub-categories for respective events. Furthermore, host is capable of processing reports to establish priorities for events and provide recommended courses of action in addition to the deployment messages discussed above. Other capabilities, such as error handling/logging, error notification, memory management, data layer/business layer management are contemplated as well. Host 100 is preferably configured to support multiple client, multiple departments for client, multiple employees per department/client, all pertinent data (event categories, sub-categories, submission date(s) first/last names, email, house address, street prefixes, street type (Dr, Ln, etc.), street suffix, city, state zip, day phone, evening phone, etc.)

In general, host 100 is also responsible for virtualizing all database access, which would allow, among other things, access from multiple devices and platforms, as well as the ability to separate hosted application(s) from a database server. Host 100 would also provide hosted translation services to allow system 110 to decode or translate latitude/longitude measurements into addresses, and vice versa. Based on the performance of live location translation services, the location processing can be offloaded to a batch process and scheduled to run at predetermined time periods (e.g., every 2 minutes). Additionally, host 100 has access to one or more relational, object-oriented, object-relational and/or probabilistic databases through which host 100 performs processing for determining dispatch priorities and for relating multiple events.

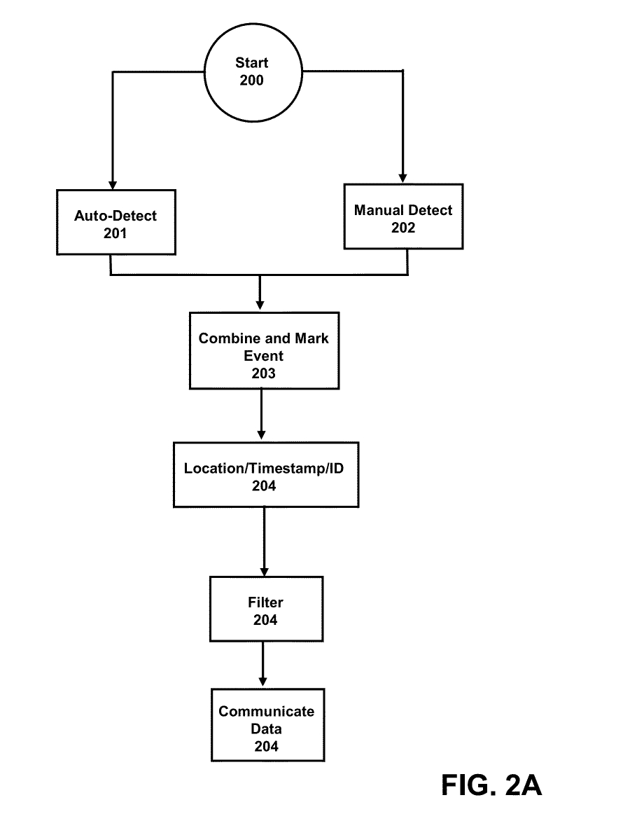

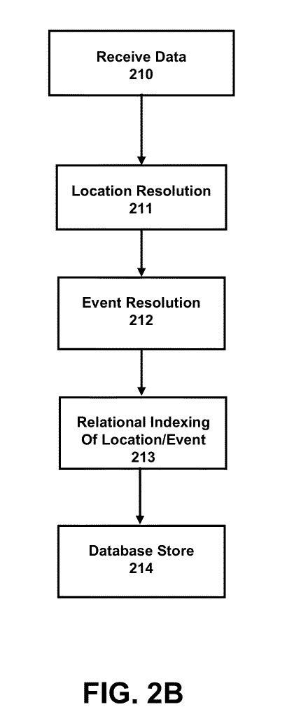

Turning to FIG. 2A, an exemplary reporting process is disclosed. Using the cell phone 103 example discussed above, a cell phone, or similar device, is loaded with appropriate software that allows users to enter and communicate event data from cell phone 103 to Internet 102. The software is preferably configured to obtain data generated from a cell phone camera, global positioning (GPS), a built-in accelerometer (e.g., LIS302DL) and a cell phone entry device, such as a keypad or touch screen. At the start 200 of the process, the cell phone captures or detects event data automatically 201 and/or manually 202.

As an example, data collected automatically (or “passively”) may come from the cell phone's accelerometer, which would detect movements along a 3-dimensional or 2-dimensional axis. When the cell phone user is driving, bumps or other jarring events would result in a displacement of the phone, indicating that a road deformity (e.g., pothole) has been struck. When this happens, the phone records an event signal. Concurrently, the cell phone's GPS location is recorded, along with a time stamp, which is combined with the event signal. The combined event signal is then associated with user identification data, which is typically stored on the cell phone's SIM card or other memory location. This information is then combined into an event message that is ultimately transmitted over the Internet (204) to host 100.

In the case of event data being recorded or detected manually 202, the user presses a button on the phone, indicating an event has occurred. An event signal is generated, stored and subsequently combined with a time stamp and GPS data, as well as user ID data, discussed above. The event signal triggers the phone software to produce a graphic menu on the cell phone, which allows the user to specify the type of event that has occurred (e.g., pothole, flood, graffiti, etc.). Sub-menus may also be provided on the cell phone to get further information on the event. Additionally, the event signal can trigger the cell phone software to activate a cell phone camera and/or microphone to allow the user to visually and/or audibly record the actual event. In such a case, the visual/audible recording is associated with the event signal and stored. The software then combines all the data associated with the even signal to produce an event message, which is ultimately transmitted over the Internet (204) to host 100.

In step 203, the cell phone software combines and marks events. The step of combining refers to instances where multiple event signals may be combined into a more detailed event message. In this embodiment, combinations of automatically detected event signals and manually detected event signals can be generated. For example, if an accelerometer displacement has occurred, indicating a potential pothole, a menu screen can be presented, requiring manual input from the user (e.g., “the software detected a pothole—please press button to confirm”). Alternately, multiple automatic detections may be combined. For example, the software may be configured in a manner where, when a first accelerometer displacement occurs, the user is given a predetermined time period to shake the phone a second time to confirm the first displacement. Such a configuration can be advantageous in driving situations, where user access to a cell phone's keypad is not safe or practicable. During the combination process, the two displacements are combined to indicate (mark) that the event message is confirmed by the user.

Those skilled in the art will appreciate that the examples above are for the purpose of illustration only and that other configurations are possible. For example, instead of GPS coordinates, the phone may rely on triangulation, WiFi hotspots or Bluetooth™ connections to establish location data. Voice commands can also be used to confirm event signals that are recorded as well.

While the location/timestamp/ID data may be concurrently appended during the creating of an event signal discussed above, it may also be appended in step 204 following any combination performed in step 203. Such a configuration is preferable in cases where event signal combinations are used as a means of confirmation. In the event an event signal is not confirmed, the event signal may be purged from memory, making the addition of location/timestamp/ID data unnecessary. In step 204 a filtering process may be added to further enhance accelerometer data. The filter would preferably be configured to pass through accelerometer displacements exceeding a certain threshold value. Such a configuration would be advantageous in cases where automatically detected event data is likely to be valid, but is unconfirmed due to an inadvertent omission by the user. In such a case, the event data would be communicated in step 204, providing that the accelerometer data associated with the event signal exceeds the filter's threshold.

FIG. 2B illustrates an exemplary process for processing event data produced in the embodiment of FIG. 2A. Starting with step 210, the host 100 receives the incoming event data 210 and executes a location resolution process 211 to resolve location data, as well as convert location data from one form to another (e.g., longitude/latitude to an address or “nearest address”). During the resolution process, further connections may be provided to a dedicated GPS server, or telephone provider location server, to confirm locations recorded on the device at the time of the event. Additional algorithms may be provided to allow the location resolution process 211 to adjust or modify location skews attributed to network time lags or user/device delays when entering or recording events.

In step 212, host 100 executes an event resolution process 212 which serves to identify event types, process, and prioritize events received from users. Further processing capabilities are performed in step 213 using relational, object-oriented, object-relational and/or probabilistic databases to compare events to determine (1) duplicate entries of an event reported from one location by a single user, (2) duplicate entries of an event reported from one location from different users, (3) multiple entries of different events reported from one location by one or more users, and (4) “event clusters” comprising multiple events reported by one or more users from different locations related to a confined area (e.g., city block, intersections, bridge overpass). Through the resolution process, events or event clusters may assigned a priority value, and previous priority values may be updated based on any of comparisons (1)-(4).

The event clusters can be used to identify “mega-events” which may be defined as a combination of events that collectively indicate or suggest a larger event. These mega-events can be defined in the present system by specifying specific locations in a geographic area and assigning event types and frequencies for the locations. If the predetermined event types and frequencies are detected for the locations, the system signals a mega-event for the geographic area. As an example, a mega-event may be designed for a bridge area by assigning locations along the bridge's span (such as stress/load points), and further assigning events, such as cracks, that may appear at the assigned locations. If multiple “crack” events are reported at a predetermined amount of locations, these occurrences collectively signal a mega-event, indicating that more serious structural damage is present. After the processing of step 213 is completed, the event(s) and/or mega-event(s) are assigned a priority and the results are then stored in step 214.

Event clusters and other event data may also be used to provide statistical data and provide the basis for models used to predict future problems. For example, numerous events in a geographic area can be subjected to probabilistic/statistical modeling, including empirical probability and/or distribution function algorithms to determine future areas of concern based on current event data. Such reports would allow localities to focus on potential issues well in advance, providing the capability to conduct proactive repairs that were not possible in the prior art. Examples of probability techniques for determining areas of concern based on current event data include Poisson distribution, Bernoulli distribution, binomial distribution, geometric distribution, and negative binomial distribution.

More sophisticated processing may be accomplished if event data is tied into an expenditures database in order to monitor and dispatch crews according to cost allocation criteria. In many instances, dispatch may be based on a combination of (i) the type and severity of an event and (ii) the cost allocation for event types. In cases where different event types are being reported in a given time period, dispatch priority may be based on cost allocations for each of the types. Accordingly, dispatch for multiple event types of equal severity may be prioritized using cost allocation values for each event type (e.g., event having highest cost allocations are prioritized higher). Additional information regarding econometric models for maintenance and rehabilitation expenditures may be found in Li, Z., and K. C. Sinha, “A Methodology to Estimate Load and Non-Load Shares of Highway Pavement Routine Maintenance and Rehabilitation Expenditures. Publication FHWA/IN/JTRP-2000/04. Joint Transportation Research Program, Indiana Department of Transportation and Purdue University, West Lafayette, Ind., 2000.

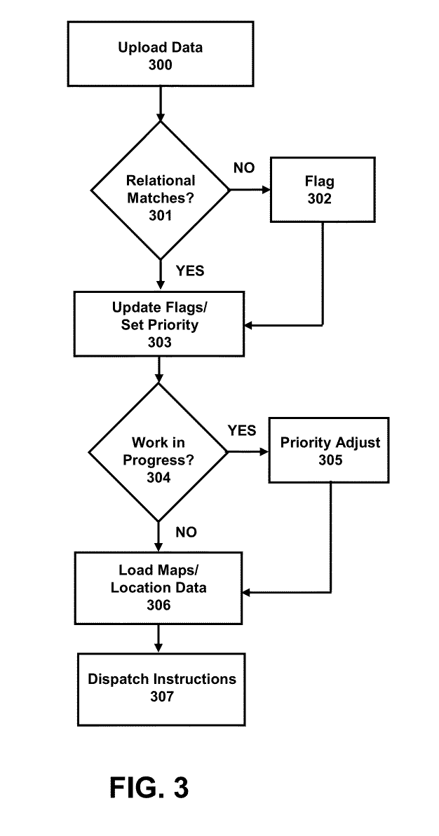

Turning to FIG. 3, an exemplary dispatch reporting process is disclosed, using host 100 and workstation 107 discussed previously in connection with FIG. 1. After the stored data is uploaded 300, a relational match is conducted to determine if an event and/or location was previously received in the system. If the event and/or location were not received (“NO”), the event is flagged in step 302 and assigned a priority value in step 303. Under a preferred embodiment, the priority value is automatically assigned according to event type and/or location. If the event and/or location were received previously (“YES”) a relational flag is assigned so that the event and/or location can be associated with the previously received data. Additionally a relational priority value is provided in 303 to indicate that the priority for the event and/or location may need to be adjusted relative to the previously received data.

In step 304, a determination is made if the event was previously dispatched, i.e. is it a “work in progress.” If the answer is “YES” the process moves to step 305, where the priority value may be adjusted up or down. The adjustment may be made according to a time comparison between the current event and a previous event already dispatched in the system. If the time comparison yields a relatively short time period (e.g., 8 hours, 1 day, etc.), this would indicate that the event is in the normal process of dispatch, and the later-received event's priority would be adjusted down. However, if the time comparison yields a longer time period (e.g., 5 days, one week, etc.), this would indicate that a problem occurred in the previous dispatch, and corrective action should be taken. As such, the currently-received priority value would be adjusted up.

After the process of step 304 is completed, the event data is logged and processed to provide data that may be graphically imported as locations in a loaded map of an area 306. After determining the relative locations of events to available crews, dispatch instructions are provided in step 307.

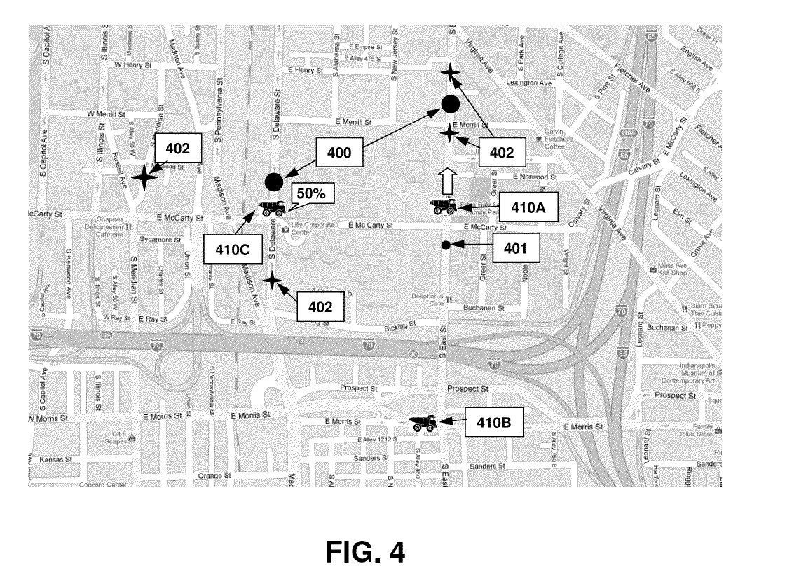

Turning to FIG. 4, an exemplary graphical depiction of events and available crews is shown. Here, two different event types (400-401 and 402) at various locations are depicted on the map, along with detected or known locations of crews (410A-410C). Regarding the first event type (400, 401), the relational processing described above allows the map to graphically depict events according to an assigned priority. In this example, event 401 is assigned a lower priority and is depicted as a smaller graphic image. However, events 400 are assigned with a higher priority and are accordingly shown as larger graphic images. Such a configuration is desirable to allow dispatchers to quickly determine the location and urgency of events.

A second event is depicted as a different graphic image 402, and is also mapped relative to crews 410A-410C and first event 400-401. While not illustrated in FIG. 4, it is understood that the second event may also be displayed in a smaller or larger format according to priority. It is also understood that numerous additional events and corresponding images may be provided according to the needs of the designer.

Dispatch instructions are preferably provided according to the detected or known locations of crew vehicles 410A-410C. Under one embodiment, dispatch messages are provided using wireless messaging, preferably to one or more cell phones (see FIG. 1, refs. 108, 109) configured with software capable of interacting with the dispatching system. For example, since crew 410A is closest high-priority event 400 (located north of crew 410A in the map of FIG. 4), a message would be dispatched to crew 410A, preferably including directions for getting to event 400. After receiving the dispatch message, crew 410A would acknowledge receipt, completing the initial dispatch.

The crew cell phone dispatch software would preferably be equipped with a work status updater, embodied as a task completion interface with predetermined task completion milestone estimations (e.g., 0%, 25%, 50%, 75%, and 100%). As work progresses, the dispatcher is informed of the status of work in real time, and allows the dispatcher to make near real-time adjustments to crew assignments. Under a preferred embodiment, a status request message is automatically generated from workstation 107 or host 100 at regular intervals (e.g., 2 hours) to one or more crew cell phones, where the status request message automatically executes the task completion interface on the cell phone(s). When an authorized crew member enters the task completion milestone estimation into the phone (e.g., 50%), the status of the work is transmitted back to the dispatcher and automatically loaded in the graphical interface, illustrated in FIG. 4 near crew icon 410C. This feature advantageously allows the dispatcher to oversee crew progress and availability on a wide scale.

Regarding the web system interface, each departmental government agency, for example, will be able to follow the status on each work order by logging into a web portal (e.g. government internal tracking portal), where a live data map web portal would show events and locations as they come in. When the department crews are ready to go out and do the work, the department head will use a route generation feature found in the portal as follows:
a. The system will, based on events recorded, priority, and number of people available to do repairs, divide the work and generate routes for them.
b. Once this is done, the system will create a key for each route.
c. This key will be given to each crew.
d. The crew then executes a mobile application (e.g. “GoFixIt” mobile app) and enters the key provided.
e. The mobile app will connect to the system and download the places where they need to go.
f. As they repair events, they mark status to indicate progress; when repairs are complete, the system and events can be triggered (e.g., automated call, SMS message, MMS message, email, etc.) to the individuals that reported the problem.
g. Behind the scenes, the system will record various time stamps which later on can help with scheduling, planning, etc.

Different reporting tools as well as a “Live Dashboard portal” will provide each department head with key performance indicators, and allows supervisors to establish productivity metrics for one or more crews.

Host 100 may also provide a public web portal for interfacing with one or more computing devices 104 to allow entry of requests regarding events observed by users. An exemplary user request process is described below:
a. User selects event category for request (e.g., animals, streets, signs, signals, environment, trash, graffiti, dumping, zoning violations, abandoned vehicles).
b. User selects sub-category, preferably listed under the category.
c. User selects location, either by typing the address or by selecting a point on a graphical map.
d. User selects one or more lower sub-categories associated with a specific sub-category. Sub-categories and lower sub-categories are preferably arranged in a tree node configuration in the menu to allow for specific entries depending on the category/sub-category selected.
e. Comments are added (but are not necessarily required)
f. An anonymous data form is provided, if user selects to report event anonymously.
g. A user data form is provided, if the user selects to report the event using personal information (which may or may not be required, depending on the needs of the system designer), such as
   1. First Name
   2. Last Name
   3. Email
   4. House #
   5. Street Prefix (N, S, E, W)
   6. Street Name
   7. Street Type (Dr, Ln, etc.)
   8. Street Suffix
   9. City
   10. State
   11. Zip
   12. Day Phone
   13. Even Phone
      After entry, the system will capture submission time and date. Under a preferred embodiment, request screen are dynamically created based on category and sub-category. This allows the web interface to dynamically alter the number of fields and control types used (e.g., regular text boxes, drop downs, radio buttons, etc.). Additionally, users will be given the option of checking the status of the request, and also be provided with a Help option that would provide assistance. Reporting for the public web portal in Host 100 allows the portal to report usage statistics from clients and determine metrics related to number of visits/uses, number of requests submitted, etc.

The public web portal administrative section would provide the abilities to create/update new clients/users, so that each client/user is provided with an administrative account. The administrative section would also provide abilities to create categories, sub-categories and fields for events, and also provide the ability to assign or reassign categories and such to specific departments.

A government internal tracking web portal is also preferably provided by host 100 to provide further data entry and processing. For example, a government internal tracking web portal may be configured in the following manner:
Users will be required to log in.
Each user will have a profile that will determine (among other things) access rights, which queues they can see, etc.
Work orders will be created the moment requests are submitted (Call Center or Public Portal). This requests will be assigned a Registered status.
Status definitions:
   Registered: New work order (WO). It has not been assigned yet.
   Submitted: “Front Desk” employee assigns WO to a department.
   Acknowledge: Employee in the department acknowledges the WO.
   Assigned: WO has been assigned to a crew and it is ready to being worked on.
   Priority: the urgency of a specific WO.
   Reassigned: Department reassigns ticket to another department or back to front desk.
   Rejected: Department rejects ticket and goes back to front desk.
   Work in Progress: Crew out doing the job.
   Status: level of progress/completion of work.
   Paused: Crew needs to pause the WO. Should give reason why.
   Resolved: Crew/department has finished the work (but not final paperwork).
   Completed: Crew/department completed all aspects of this task. At this point a requesting user may be notified of the completion.
System will track “who” and “when” on every action.
   Example: An employee changes the status on ticket, a note should be required from employee and the system will record time, date and user name.
Question: Does the system need to notify certain employees upon status changes?
Define levels of access rights based on client organizational structure.
Route generation.

For administrative tools in the government internal tracking portal, administrators are given the ability to create and/or update users, categories, sub-categories, further sub-categories and other information relating to events. The government internal tracking portal can also provide reports on usage, requests, timing, and other information discussed above. Preferably, a “live dashboard” communicates statistics and other data relating to requests, events, dispatch, average times to assign/complete, event clusters, etc. As discussed above, a live data map provides a graphical depiction of events, crew location, status, as well as other information.

Although various embodiments of the present invention have been described with reference to a particular arrangement of parts, features and the like, these are not intended to exhaust all possible arrangements or features, and indeed many other embodiments, modifications and variations will be ascertainable to those of skill in the art.

What is claimed is:

1. A method for monitoring event data in a computer system to determine dispatch for repair, comprising the steps of:
receiving event data in the computer system comprising information on an environmental condition at a location, wherein the event data further comprises time data and identification data for the sender that reported the event data;
performing an event resolution process on the event data in the computer system to determine an event data type, wherein the resolution process further compares the event data type to at least one of (i) other event data being the same event data type, and (ii) other event data for the location;
assigning a priority in the computer system to the event data based on the event resolution process;
determining locations of a plurality of work crews in a geographic area that includes the location; and
generating a dispatch instruction comprising the event data, event data type and priority.

2. The method of claim of 1, wherein the event resolution process comparison comprises a determination of at least one of:
(1) duplicate entries of event data reported from the location by the sender,
(2) duplicate entries of event data reported from the location from different senders,
(3) multiple different event data types reported from one location by one or more senders, and
(4) multiple events reported by one or more users from other locations proximate to the location.

3. The method of claim 2, wherein new event data is formed in the computer system when the resolution process determines multiple events reported by one or more users from other locations proximate to the location.

4. The method of claim 3, wherein a new priority is assigned to the new event data.

5. The method of claim 1, further comprising the step of selecting at least one of the plurality of work crews in the geographic area for receiving the dispatch instruction.

6. The method of claim 5, further comprising the step of receiving progress data from the at least one selected work crew in response to the dispatch instruction.

7. The method of claim 6, further comprising the step of assigning an updated priority in the computer system to the event data, based on the received progress data.

8. A computer system for monitoring event data to determine dispatch for repair, comprising:
an input for receiving event data comprising information on an environmental condition at a location, wherein the event data further comprises time data and identification data for the sender that reported the event data;
a memory for storing said event data received from said input,
a processor, operatively coupled to the input and the memory, wherein the processor is configured to perform an event resolution process on the event to determine an event data type, wherein the resolution process further compares the event data type to at least one of (i) other event data being the same event data type, and (ii) other event data for the location;
wherein the processor is further configured to assign a priority to the event data based on the event resolution process;
wherein the processor is further configured to establish locations of a plurality of work crews in a geographic area that includes the location; and
wherein the processor is configured to generate a dispatch instruction comprising the event data, event data type and priority.

9. The system of claim of 8, wherein the event resolution process comparison comprises a determination of at least one of:
(1) duplicate entries of event data reported from the location by the sender,
(2) duplicate entries of event data reported from the location from different senders,
(3) multiple different event data types reported from one location by one or more senders, and
(4) multiple events reported by one or more users from other locations proximate to the location.

10. The system of claim 9, wherein the processor forms new event data when the resolution process determines multiple events reported by one or more users from other locations proximate to the location.

11. The system of claim 10, wherein the processor assigns a new priority to the new event data.

12. The system of claim 8, wherein the processor is further configured to select at least one of the plurality of work crews in the geographic area for receiving the dispatch instruction.

13. The system of claim 12, wherein the input is configured to receive progress data from the at least one selected work crew in response to the dispatch instruction.

14. The system of claim 13, wherein the processor assigns an updated priority in the computer system to the event data, based on the received progress data.

15. A computer-implemented method for managing dispatch for repair, comprising the steps of:
receiving event data in a computer system comprising information on an environmental condition at a location, wherein the event data further comprises time data and identification data for the sender that reported the event data;
performing an event resolution process on the event data in the computer system to determine an event data type, wherein the resolution process further assigns a priority to the event data based on a comparison of the event data type to at least one of (i) other event data comprising the same event data type, and (ii) other event data for the location;
selecting at least one of a plurality of work crews identified in a geographic area that is within a predetermined proximity to the location, and generating a dispatch instruction comprising the event data, event data type and priority;
assigning a dispatch priority to the dispatch instruction;
receiving progress data from the at least one selected work crew; and
updating at least one of (i) the assigned dispatch priority and (ii) assigned event data priority based on the progress data.

16. The method of claim of 15, wherein the event resolution process comparison comprises a determination of at least one of:
(1) duplicate entries of event data reported from the location by the sender,
(2) duplicate entries of event data reported from the location from different senders,
(3) multiple different event data types reported from one location by one or more senders, and
(4) multiple events reported by one or more users from other locations proximate to the location.

17. The method of claim 16, wherein new event data is formed in the computer system when the resolution process determines multiple events reported by one or more users from other locations proximate to the location.

18. The method of claim 17, wherein a new priority is assigned to the new event data.

19. The method of claim 18, wherein the new priority is used to update the dispatch priority.

20. The method of claim 18, comprising the step of generating another dispatch instruction comprising the new event data and new priority.
